(19) United States
(12) Patent Application Publication
(10) Pub. No.: US 2020/0413255 A1
(43) Pub. Date: Dec. 31, 2020

(54) USER IDENTIFICATION IN RADIO FREQUENCY ENVIRONMENTS

(71) Applicant: QUALCOMM Incorporated, San Diego, CA (US)

(72) Inventors: Arthur James, San Jose, CA (US); Srdjan Miocinovic, Los Gatos, CA (US)

(21) Appl. No.: 16/455,423

(22) Filed: Jun. 27, 2019

(51) Int. Cl. H04W 12/06; H04L 29/08; H04L 12/26; H04W 28/02; H04W 48/06; H04L 29/06

(52) U.S. Cl. CPC H04W 12/06; H04L 67/306; H04L 43/0864; H04W 84/18; H04W 48/06; H04L 63/0861; H04W 28/021

(57) ABSTRACT

This disclosure provides methods, systems, and devices for user authentication in radio frequency environments. In one aspect, an access point (AP) may collect channel information from a station (STA) in a mesh network, and receive, from a cloud platform, a user profile including a fingerprint of the STA and fingerprint of a user associated with the STA based on the collected channel information. The AP may determine a profile of wireless traffic from the STA in the mesh network and identify the STA and the user associated with the STA based on comparing the user profile to the profile of the wireless traffic. As a result, the AP may authenticate the STA and the user associated with the STA based on the comparison.

### TECHNICAL FIELD

This disclosure relates to user identification in radio frequency environments.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. Some examples of wireless communications systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems.

The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via DL and UL. The DL (or forward link) may refer to the communication link from the AP to the STA, and the UL (or reverse link) may refer to the communication link from the STA to the AP. Some example STAs may support user identification and verification methods. Although these methods may be generally effective, these methods may be inefficient due to demand of user interaction to accomplish the user identification and verification. Improved methods capable of robust user identification exclusive of user interaction may be desired.

### SUMMARY

The described techniques relate to improved methods, systems, devices, and apparatuses for multi-modal user identification and classification that support the configuration of access points (APs) of a network to provide pervasive user identification to applications in a network environment (such as a Wi-Fi mesh network). Software agents (also referred to as user identification agents) in the network environment may collect and transmit information, for example, such as channel state information (CSI) from multiple stations (STAs) to a cloud-based device (such as a machine learning cloud). The cloud-based device may use the CSI to learn and provide user profiles including unique fingerprints to the software agents. As a result, the software agents may monitor wireless traffic and correlate fingerprints of the STAs and fingerprints of users with a corresponding wireless traffic fingerprint that flows from and to the STAs for improved user identification. Accordingly, the described methods, systems, devices, and apparatuses provide multi-modal user identification and classification techniques that may improve user identification without user interaction, thereby enhancing security and user experience. The described techniques may therefore include features for transparent and pervasive user identification in a radio frequency environment, among other benefits.

One innovative aspect of the subject matter described in this disclosure can be implemented in a method at an AP. The method may include collecting channel information from a STA in a mesh network, receiving, from a cloud platform, a user profile including one or more of a fingerprint of the STA and a fingerprint of a user associated with the STA based on the channel information, determining a profile of wireless traffic from the STA in the mesh network, identifying one or more of the STA and the user associated with the STA based on comparing the user profile to the profile of the wireless traffic, and authenticating one or more of the STA and the user associated with the STA based on the identifying.

Another innovative aspect of the subject matter described in this disclosure can be implemented in an apparatus. The apparatus may include a processor, memory coupled with the processor, and instructions stored in the memory. The instructions may be executable by the processor to cause the apparatus to collect channel information from a STA in a mesh network, receive, from a cloud platform, a user profile including one or more of a fingerprint of the STA and a fingerprint of a user associated with the STA based on the channel information, determine a profile of wireless traffic from the STA in the mesh network, identify one or more of the STA and the user associated with the STA based on comparing the user profile to the profile of the wireless traffic, and authenticate one or more of the STA and the user associated with the STA based on the identifying.

Another innovative aspect of the subject matter described in this disclosure can be implemented in an apparatus. The apparatus may include means for collecting channel information from a STA in a mesh network, receiving, from a cloud platform, a user profile including one or more of a fingerprint of the STA and a fingerprint of a user associated with the STA based on the channel information, determining a profile of wireless traffic from the STA in the mesh network, identifying one or more of the STA and the user associated with the STA based on comparing the user profile to the profile of the wireless traffic, and authenticating one or more of the STA and the user associated with the STA based on the identifying.

One innovative aspect of the subject matter described in this disclosure can be implemented in a non-transitory computer-readable medium storing code at an AP. The code may include instructions executable by a processor to collect channel information from a STA in a mesh network, receive, from a cloud platform, a user profile including one or more of a fingerprint of the STA and a fingerprint of a user associated with the STA based on the channel information, determine a profile of wireless traffic from the STA in the mesh network, identify one or more of the STA and the user associated with the STA based on comparing the user profile to the profile of the wireless traffic, and authenticate one or more of the STA and the user associated with the STA based on the identifying.

In some examples of the method, apparatuses, and non-transitory computer-readable medium described herein, collecting the channel information may include operations, features, means, or instructions for receiving CSI from the STA, the CSI including a measurement of one or more orthogonal frequency-division multiplexing (OFDM) carriers associated with the STA.

In some examples of the method, apparatuses, and non-transitory computer-readable medium described herein, collecting the channel information may include operations, features, means, or instructions for monitoring round trip information between the STA and the AP in the mesh network, where the round trip information includes one or more of a round trip time, a round trip phase offset, and an angle of arrival.

In some examples of the method, apparatuses, and non-transitory computer-readable medium described herein, collecting the channel information may include operations, features, means, or instructions for monitoring one or more of a signal strength, a signal power, and a signal quality of the STA in the mesh network.

In some examples of the method, apparatuses, and non-transitory computer-readable medium described herein, collecting the channel information may include operations, features, means, or instructions for obtaining biometric information from the user associated with the STA, where the biometric information includes one or more of voice recognition information, facial recognition information, or physiological recognition information.

In some examples of the method, apparatuses, and non-transitory computer-readable medium described herein, determining the profile of the wireless traffic from the STA in the mesh network may include operations, features, means, or instructions for determining that the wireless traffic may be associated with a value-added service, authenticating one or more of the STA and the user associated with the STA to the value-added service based on comparing the user profile to the profile of the wireless traffic relating to the value-added service, and transmitting authentication credentials to the value-added service based on the authentication.

Some examples of the method, apparatuses, and non-transitory computer-readable medium described herein may further include operations, features, means, or instructions for identifying a policy setting associated with the value-added service, where authenticating the one or more of the STA and the user associated with the STA to the value-added service may be further based on the policy setting.

Some examples of the method, apparatuses, and non-transitory computer-readable medium described herein may further include operations, features, means, or instructions for determining additional information of the user associated with the STA based on the policy setting, the additional information including biometric information, temporal information, location information of an additional STA associated with the user, or usage information of the additional STA associated with the user, where identifying the one or more of the STA and the user associated with the STA may be further based on the additional information.

In some examples of the method, apparatuses, and non-transitory computer-readable medium described herein, transmitting the authentication credentials to the value-added service may include operations, features, means, or instructions for including a token in a header of a packet associated with the wireless traffic relating to the value-added service, the token including the authentication credentials.

In some examples of the method, apparatuses, and non-transitory computer-readable medium described herein, determining the profile of the wireless traffic from the STA in the mesh network may include operations, features, means, or instructions for determining a difference between the user profile and the profile of the wireless traffic based on the comparing, and identifying an additional user profile of the user associated with an additional STA in the mesh network, where identifying the one or more of the STA and the user associated with the STA may be further based on comparing the additional user profile to the profile of the wireless traffic.

In some examples of the method, apparatuses, and non-transitory computer-readable medium described herein, determining the profile of the wireless traffic from the STA in the mesh network may include operations, features, means, or instructions for determining a difference between the user profile and the profile of the wireless traffic based on the comparing, determining that an other user may be operating the STA based on the difference between the user profile and the profile of the wireless traffic, and performing an action according to a setting of the STA based on the other user operating the STA.

In some examples of the method, apparatuses, and non-transitory computer-readable medium described herein, performing the action according to the setting of the STA may include operations, features, means, or instructions for preventing access to one or more features of the STA.

Some examples of the method, apparatuses, and non-transitory computer-readable medium described herein may further include operations, features, means, or instructions for performing an authentication and verification of the AP to the cloud platform, the authentication and verification including one or more of a STA identifier and a security mode of the AP, where transmitting the channel information to the cloud platform may be further based on the authentication and verification.

In some examples of the method, apparatuses, and non-transitory computer-readable medium described herein, comparing the user profile to the profile of the wireless traffic may include operations, features, means, or instructions for comparing one or more of the fingerprint of the STA and the fingerprint of the user associated with the STA to a fingerprint of the wireless traffic.

Some examples of the method, apparatuses, and non-transitory computer-readable medium described herein may further include operations, features, means, or instructions for generating a local database including a set of users associated with the STA, a set of user profiles including a set of fingerprints, each fingerprint of the set corresponding to different users of the set of users, and a set of policies corresponding to the set of users, where comparing the user profile to the profile of the wireless traffic may be further based on the local database.

Some examples of the method, apparatuses, and non-transitory computer-readable medium described herein may further include operations, features, means, or instructions for transmitting the channel information to the cloud platform, where receiving, from the cloud platform, the user profile may be based on the transmitting, and the user profile may be determined based on a machine learning scheme.

Details of one or more implementations of the subject matter described in this disclosure are set forth in the accompanying drawings and the description below. Other features, aspects, and advantages will become apparent from the description, the drawings and the claims.

### BRIEF DESCRIPTION OF THE DRAWINGS

FIGS. 1 and 2 illustrate an example of a system for multi-modal user identification classification that supports user identification in radio frequency environments.

FIG. 3 shows a block diagram of an example access point (AP) that supports user identification in radio frequency environments.

FIG. 4 shows a block diagram of an example cloud system that supports user identification in radio frequency environments.

FIGS. 5 and 6 show block diagrams of example devices that support user identification in radio frequency environments.

FIG. 7 shows a block diagram of an example authentication manager that supports user identification in radio frequency environments.

FIG. 8 shows a diagram of an example system including a device that supports user identification in radio frequency environments.

FIGS. 9 and 10 show flowcharts illustrating methods that support user identification in radio frequency environments.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

The described techniques relate to improved methods, systems, devices, and apparatuses for multi-modal user identification and classification that support configuration of access points (APs) of a mesh network to provide pervasive user identification to applications in a network environment (such as a mesh network). According to aspects described herein, software agents (also referred to as user identification agents) in the network environment may collect and transmit information, for example, such as channel state information (CSI) from multiple STAs to a cloud-based device (such as a machine learning cloud). The cloud-based device may use the CSI to learn and provide user profiles including unique fingerprints to the software agents. As a result, the software agents may monitor network traffic and correlate fingerprints of the STAs and fingerprints of users with a corresponding network traffic fingerprint that flows from and to the STAs for robust user identification. Accordingly, the described techniques may provide multi-modal user identification and classification techniques which may strengthen user identification.

By way of example, an AP, in some examples, may collect channel information from a STA in a mesh network and transmit the information to a cloud platform to determine, according to a machine learning scheme, a user profile based on the channel information. The AP receive, from the cloud platform, the user profile including one or more of a fingerprint of the STA and a fingerprint of the user associated with the STA. The AP may monitor or continue to monitor wireless traffic from the STA in the mesh network and identify one or more of the STA and the user associated with the STA based on comparing the user profile to a profile of the wireless traffic. As a result, the AP may authenticate one or more of the STA and the user associated with the STA. The described techniques may therefore include features for transparent and pervasive user identification without user interaction in a radio frequency environment, among other benefits.

In some examples, the described techniques may provide continuous and automatic device and user identification based on learned user profiles and may be combined with additional features for identifying and verifying users. For example, according to aspects described herein, the techniques disclosed may additionally incorporate biometric verification (such as detection of user's voice within proximity of device), peripheral device detection (e.g. wearables such as watches, earbuds, fitness bands, etc. having associated radio frequency fingerprints), and radio frequency sensory inputs (such as Bluetooth (BT) and Wi-Fi received signal strength indicators, a round trip time, a round trip phase offset, an angle of arrival, and radar doppler measurements) to further strengthen user identification. Further, example aspects of the techniques may include granting or denying access to services or device features in accordance with an identified device or user.

Particular aspects of the subject matter described herein may be implemented to realize one or more advantages. The described methods, systems, devices, and apparatuses provide multi-modal user identification and classification techniques which may support improved user identification, among other advantages. As such, supported techniques may include features for enhancing security and user experience. Additionally, the improved techniques provide user identification and classification techniques that may reduce or eliminate dependencies on user interaction for user identification procedures.

Aspects of the disclosure are initially described in the context of a system. Aspects of the disclosure are also described in the context of a user identification agent and a cloud system. Aspects of the disclosure are further illustrated by and described with reference to apparatus diagrams, system diagrams, and flowcharts that relate to user identification in radio frequency environments.

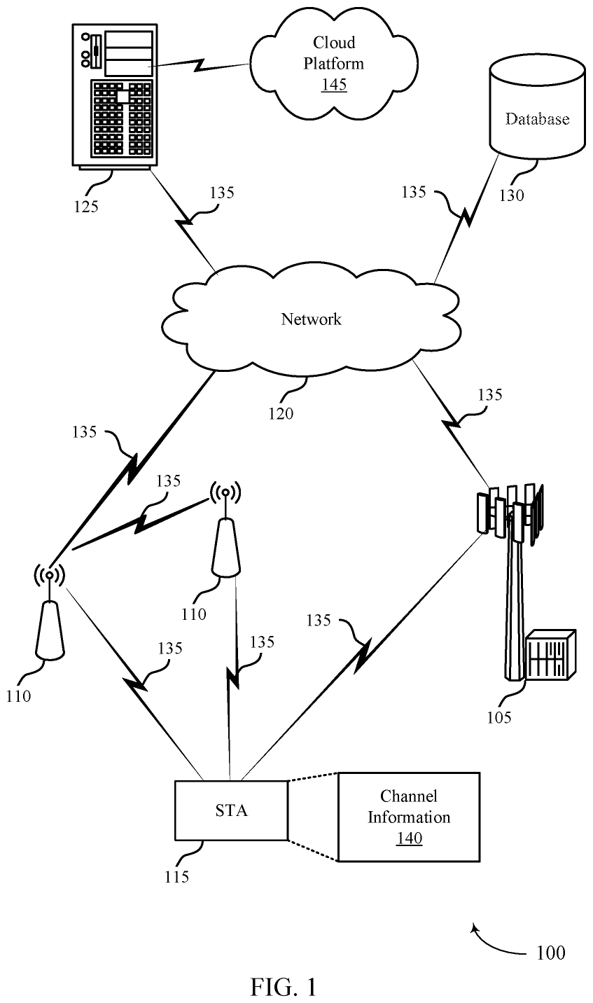

FIG. 1 illustrates an example of a system 100 for multi-modal user identification classification that supports user identification in radio frequency environments. The system 100 may include a base station 105, APs 110, a STA 115, a server 125, a database 130, and a cloud platform 145. The base station 105, the APs 110, the STA 115, the server 125, and the database 130 may communicate with each other via network 120 using communications links 135. In some examples, the system 100 may support transparent and pervasive user identification in a radio frequency environment without user involvement, among other benefits.

The base station 105 may wirelessly communicate with the STA 115 via one or more base station antennas. Base station 105 described herein may include or may be referred to by those skilled in the art as a base transceiver station, a radio base station, a radio transceiver, a NodeB, an eNodeB (eNB), a next-generation Node B or giga-nodeB (either of which may be referred to as a gNB), a Home NodeB, a Home eNodeB, or some other suitable terminology. The STA 115 described herein may be able to communicate with various types of base stations and network equipment including macro eNBs, small cell eNBs, gNBs, relay base stations, and the like.

The APs 110 may be configured to provide wireless communications for the STA 115 over a relatively smaller area compared to the base station 105. In some examples, the APs 110 may be configured to receive channel information 140 from the STA 115. In some examples, the channel information 140 may include one or more of a signal strength, a signal power, and a signal quality of the STA 115. In some examples, the STA 115 may measure one or more aspects of one or more orthogonal frequency-division multiplexing (OFDM) carriers associated with the STA 115. For example, the STA 115 may measure the channel information 140, and the channel information 140 may include CSI, where the CSI may include a measurement of the one or more OFDM carriers associated with the STA 115. For example, the CSI may include one or more of a channel quality indicator (CQI), a precoding matrix indicator (PMI), a precoding type indicator (PTI), and a rank indication (RI) associated with one or more OFDM carriers. In some examples, the APs 110 may monitor round trip information between the STA 115 and one or more of the APs 110. The round trip information may include one or more of a round trip time, a round trip phase offset, and an angle of arrival. In some examples, the APs 110 may monitor one or more of a signal strength, a signal power, and a signal quality of the STA in the mesh network.

The APs 110 may process data (such as channel information associated with the STA 115, a user profile including one or more of a fingerprint of the STA 115 and a fingerprint of a user associated with the STA 115, a profile of wireless traffic from the STA 115, biometric information of a user associated with the STA 115, authentication credentials associated with a value-added service) from and/or write data (such as channel information associated with the STA 115, a user profile including one or more of a fingerprint of the STA 115 and a fingerprint of a user associated with the STA 115, a profile of wireless traffic, biometric information of a user associated with the STA 115, authentication credentials associated with a value-added service) to a local memory or remote memory (such as database 130). The APs 110 may therefore be configured to provide pervasive user identification and authentication in a wireless environment. For example, the APs 110 may support identification and authentication of one or more of a STA 115 and a user associated with the STA 115, based on a user profile of the STA 115 and a profile of wireless traffic, according to the techniques described herein.

In some examples, the STA 115 may be stationary and/or mobile. The STA 115 may, additionally, or alternatively, include or be referred to by those skilled in the art as a user equipment, a user device, a cellular phone, a smartphone, a Bluetooth device, a Wi-Fi device, a mobile station, a station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the STA 115 also may be able to communicate directly with another device (such as using a peer-to-peer (P2P) or device-to-device (D2D) protocol).

The STA 115 may be configured to process data (such as channel information associated with the STA 115, a user profile including one or more of a fingerprint of the STA 115 and a fingerprint of a user associated with the STA 115, biometric information of a user associated with the STA 115, temporal information, location information, or usage information) from and/or write data (such as channel information associated with the STA 115, a user profile including one or more of a fingerprint of the STA 115 and a fingerprint of a user associated with the STA 115, biometric information of a user associated with the STA 115, temporal information, location information, or usage information) to a local memory or remote memory (such as database 130). The processor may support communication and data transmission between the STA 115 and another device, for example, via direct or indirect wired or wireless communications as described herein.

The network 120 that may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (such as fifth generation (5G) for example), etc. Network 120 may include the Internet.

The server 125 may include any combination of a data server, a cloud server, a server associated with a value-added service provider, proxy server, mail server, web server, application server, a map server, a road assistance server, database server, communications server, home server, mobile server, or any combination thereof. The server 125 also may transmit to the STA 115 a variety of information, such as instructions or commands relevant to value-added services. The database 130 may store data that may include instructions or commands (such as channel information associated with the STA 115, a user profile including one or more of a fingerprint of the STA 115 and a fingerprint of a user associated with the STA 115, a profile of wireless traffic from the STA 115, biometric information of a user associated with the STA 115, authentication credentials associated with a value-added service) relevant to user identification and authentication. The APs 110 may retrieve the stored data from the database 130 via the network 120. The cloud platform 145 may be an example of a public or private cloud network that may support value-added services. The STA 115 also may be referred to here as a cloud client, which may access the cloud platform 145 over the network 120. In some examples, a cloud client may access the cloud platform 145 to store, manage, and process data associated with user identification and authentication.

The communications links 135 shown in the system 100 may include uplink transmissions from the STA 115 to the base station 105, the APs 110, or the server 125, and/or downlink transmissions, from the base station 105, the APs 110, the server 125, and/or the database 130 to the STA 115. The downlink transmissions also may be called forward link transmissions while the uplink transmissions also may be called reverse link transmissions. The communications links 135 may transmit bidirectional communications and/or unidirectional communications. Communications links 135 may include one or more connections, including but not limited to, 345 MHz, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

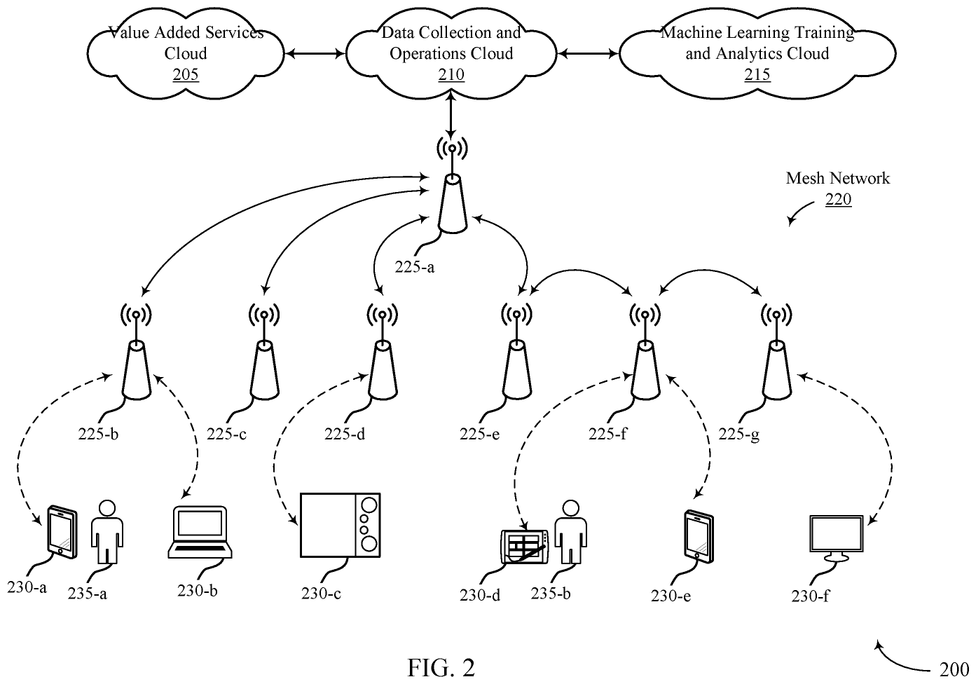

FIG. 2 illustrates an example of a system 200 for multi-modal user identification classification that supports user identification in radio frequency environments. In some examples, system 200 may implement aspects of system 100. The system 200 may include a value-added services cloud 205, a data collection and operations cloud 210, a machine learning training and analytics cloud 215, and a mesh network 220 including APs 225 and STAs 230 which may be examples of the corresponding devices described in FIG. 1. For example, the value-added services cloud 205, the data collection and operations cloud 210, and the machine learning training and analytics cloud 215 may be included in a cloud platform, such as the cloud platform 145 described in FIG. 1.

The mesh network 220 may be, for example, a Wi-Fi platform. In some examples, the mesh network 220 may be a Wi-Fi platform positioned at a network edge (such as at the edge of a cellular network). The mesh network 220 may include, for example, APs 225-a through 225-g and STAs 230-a through 230-f which may communicate certain information in the mesh network 220 for user identification. In some examples, traffic from connected STAs (such as any of the STAs 230-a through 230-f) may flow through the mesh network 220 through one or more nodes (such as APs 225 or STAs 230). The APs 225-a through 225-g may communicate (or exchange information) with each other directly, indirectly (such as via another access point), or both. In the example of FIG. 2, the AP 225-a may be in direct communication with the APs 225-b through 225-e and in indirect communication with the AP 225-f and AP 225-g (such as via AP 225-e). Each of the APs 225-a through 225-g may be an example of aspects of the AP 110 described herein, for example.

The APs 225-a through 225-g may communicate (or exchange information) with the STAs 230-a through 230-f directly, indirectly (such as via another AP), or both. In the example of FIG. 2, the APs 225-a, 225-c, and 225-e may be in indirect communication with the STAs 230-a through 230-f, the AP 225-b may be in direct communication with STAs 230-a and 230-b, the AP 225-d may be in direct communication with STAs 230-c, the AP 225-f may be in direct communication with STAs 230-d and 230-e, the AP 225-g may be in direct communication with STA 230-f Each of the STAs 230-a through 230-f may be an example of aspects of STA 115 as described herein.

Each of the STAs 230-a through 230-f may perform one or more measurements. For example, the STAs 230-a through 230-f may measure one or more aspects of one or more OFDM carriers associated with the STAs 230-a through 230-f. For example, the STAs 230-a through 230-f may measure channel information including CSI, where the CSI may include a measurement of the one or more OFDM carriers associated with the STAs 230-a through 230-f.

Additionally, or alternatively, the STAs 230-a through 230-f may measure signal information associated with the STAs 230-a through 230-f and the mesh network 220. For example, the STAs 230-a through 230-f may measure signal information such as signal strength (such as received signal strength indicator (RSSI)), signal power (such as reference signal received power (RSRP)), signal quality (such as reference signal received quality (RSRQ)), signal timing information (such as time of arrival, timing advancing information, time difference of arrival), or angle of arrival associated with the STAs 230-a through 230-f and the mesh network 220. In some examples, the signal timing information may include round trip time (RTT) (such as Wi-Fi RTT) within the mesh network 220.

For example, the STAs 230-a through 230-f (such as STA 230-a) may measure the amount of time for sending a signal to a communication endpoint in the mesh network 220 (such as any of the STAs 230-b through 230-f or the APs 225-a through 225-g) plus the amount of time for receiving an acknowledgement of the signal. In some examples, the STA 230-a may include in the measurement the propagation times for paths between the STA 230-a and the communication endpoint. Using RTT, the STAs 230-a through 230-f may determine their respective locations and respective distances to the APs 225-a through 225-g.

Examples of the STAs 230-a through 230-f may include at least one of a computing device (such as desktop, laptop), a mobile computing device (such as smart phone, tablet), control panel, sensor device (such as motion sensor, light sensor, audio sensor, camera sensor, door sensor, window sensor, fingerprint sensor, retinal scanner), sensor server, device server, automated device (such as automated light switch, automated door lock, automated thermostat, automated fans, smart televisions), automated and/or networked home appliance (such as oven, stove, microwave, refrigerator, furnace, air conditioner, heating ventilating air conditioning (HVAC) systems), a data networking device, or any combination thereof.

In some examples, the STAs 230-a through 230-f may capture and store biometric information associated with one or more users, for example, via one or more sensor devices and may store the biometric information. For example, the STA 230-a may capture a fingerprint of the user 235-a via a fingerprint sensor included in or coupled to the STA 230-a. Additionally, or alternatively, the STA 230-a may capture a voice sample of the user 235-a via a microphone, capture a facial scan of the user 235-a via a camera, capture a retinal scan of the user 235-a via the camera, etc. In some examples, the STA 230-a may request the user 235-a to present the one or more stored pieces of biometric information (such as via one or more of a fingerprint scan, a voice input, a facial scan, and a retinal scan) to access one or more features of the STA 230-a or one or more features associated with the mesh network 220.

In some examples, the STAs 230-a through 230-f may capture and store physiological information associated with one or more users, for example, via one or more sensor devices and may store the physiological information to the memory. For example, the STA 230-a may capture heart rate variability (HRV) of the user 235-a via a heart rate sensor included in or coupled to the STA 230-a. In some examples, the STA 230-a may be a smartwatch or fitness band inclusive of a heart rate monitor, or the STA 230-a may be a smartphone coupled (such as via Bluetooth or Wi-Fi) to a smartwatch, a fitness band, or a heart rate monitor. Additionally, or alternatively, the STA 230-a may measure and monitor physiological patterns associated with the user 235-a and initiate one or more applications based on variations in the physiological patterns (such as initiate a meditation application based on an elevated heart rate, contact emergency services and broadcast the location of the STA 230-a based on an indication of a heart attack or injury).

In some examples, APs 225-a through 225-g may support software agents (also referred to as user identification agents) that may collect and transmit information associated with the STAs 230-a through 230-f to other APs in the mesh network 220 (such as APs 225-a through 225-g) and to a cloud platform (such as the value-added services cloud 205, the data collection and operations cloud 210, the machine learning training and analytics cloud 215). For example, the user identification agents associated with the APs 225-a through 225-g may collect and transmit any of the channel information, signal information, and user information associated with the STAs 230-a through 230-f.

The user identification agents associated with the APs 225-a through 225-g may collect and transmit the information (such as channel information, signal information, user information) associated with the STAs 230-a through 230-f to the data collection and operations cloud 210, which may further transmit the information to the value added services cloud 205, the machine learning training and analytics cloud 215, or both. The machine learning training and analytics cloud 215 may use the information to learn and provide user profiles including unique fingerprints to the user identification agents. For example, the machine learning training and analytics cloud 215 may generate a user profile for a user (such as user 235-a) based on any combination of a device history of an STA associated with the user (such as STA 230-a, STA 230-b), user preferences, biometric information associated with the user (such as captured by any of STAs 230-a through 230-f or a connected peripheral device), and physiological patterns associated with the user (as measured by any of STAs 230-a through 230-f or a connected peripheral device). The machine learning training and analytics cloud 215 may include, for example, a neural network.

As a result, the user identification agents may monitor wireless traffic, for example, such as Wi-Fi data traffic of the STAs 230 and correlate fingerprints of the STAs 230-a through 230-f and fingerprints of users (such as users 235-a and 235-b) with a corresponding wireless traffic (such as Wi-Fi data traffic) fingerprint that flows from and to the STAs 230-a through 230-f for improved user identification. Additionally, or alternatively, the user identification agents may share profiles and update the profiles, for example, based on updates or modifications associated with the profiles (such as changes in biometric information, user preferences, reference physiological patterns). In some examples, the updates or modifications may be timestamped, and the user identification agents may update the profiles according to timestamps associated with the updates or modifications (such as the most recent updates or modifications).

The STAs 230-a through 230-f in the mesh network 220 may, in some examples, avoid having any modification to hardware or software as the channel information incorporated by the system 200 may include CSI measured from OFDM carriers. The APs 225-a through 225-g may have information on the STAs 230-a through 230-f, and may target each of the STAs 230 to collect associated channel information for fingerprinting. Additionally, the APs 225-a through 225-g may incorporate additional hardware such as microphones and far-field voice capabilities supportive of voice activated services, and may include leveraging such capabilities for capturing samples (such as voice samples) applicable to voice biometrics.

The APs 225-a through 225-g may pervasively identify users on behalf of the value-added services cloud 205 (such as retail web sites, web services, building access, online subscription services such as Netflix, etc.). For example, the APs 225-a through 225-g may identify and authenticate users on behalf of the value-added services cloud 205. In some examples, the APs 225-a through 225-g may determine a profile of wireless traffic from one or more of the STAs 230-a through 230-f in the mesh network 220.

For example, the APs 225-a through 225-g may determine that wireless traffic from the STA 230-a is associated with a value-added service provided by the value-added services cloud 205. The APs 225-a through 225-g may authenticate one or more of the STA 230-a and the user 235-a to the value-added service, based at least in part on a comparison of a received user profile to a profile of the wireless traffic in relation to the value-added service. The APs 225-a through 225-g may receive the user profile from the machine learning training and analytics cloud 215, for example, via the data collection and operations cloud 210.

In some examples, during the comparison of the user profile to the profile of the wireless traffic, the APs 225-a through 225-g may determine a difference between the user profile and the profile of the wireless traffic. In an example, the APs 225-a through 225-g may identify, based on the difference, an additional user profile of the user 235-a associated with a STA in the mesh network different from the STA 230-a. For example, for the user 235-a, the APs 225-a through 225-g may identify multiple user profiles respectively associated with the STAs 230-c, 230-d, and 230-f.

Additionally, or alternatively, the APs 225-a through 225-g may determine that another user is operating a STA based at least in part on the difference between the user profile and the profile of the wireless traffic. In an example where the STA 230-a is associated with the user 235-a (such as registered to the user 235-a), the APs 225-a through 225-g may determine, based at least in part on the difference between the user profile and the profile of the wireless traffic, that a different user (such as the user 235-b) is using or attempting to use the STA 230-a. Accordingly, in some examples, the APs 225-a through 225-g may perform an action according to a setting of the STA 230-a (such as prevent or provide limited access to one or more features of the STA 230-a, prevent or provide limited access to the mesh network 220).

In some examples, the APs 225-a through 225-g may identify a policy setting associated with the value-added service and may authenticate based at least in part on the identified policy setting. In an example, the policy setting may request additional information for authentication, such as biometric information, temporal information, location information of an additional STA (such as a smartphone, a tablet, a peripheral device such as a smartwatch, a fitness band, or a heart rate monitor) associated with the user 235-a, or usage information of the additional STA associated with the user 235-a (such as use history, connection or synch status of the additional STA with the STA 230-a of the user 235-a). Accordingly, in some examples, the APs 225-a through 225-g may transmit authentication credentials to the value-added service.

Accordingly, the APs 225-a through 225-g may grant or deny a user (such as users 235-a or 235-b) access to features of the value-added services cloud 205 or any of the STAs 230-a through 230-f without requiring a specific action (such as a user input) from the user for authentication. In an example, the value-added services cloud 205 may include access to a web site or web service, and the user 235-a may be able to access the value-added services cloud 205 via the STA 230-a (and additionally, or alternatively, a STA in communication with the STA 230-a), without providing a specific action via STA 230-a (such as entering a user login via STA 230-a). In some examples, the value-added services cloud 205 may include access to a secure location (such as an office building, a locked door, an elevator), and the user 235-a may be able to access or be authenticated by the value-added services cloud 205 via the STA 230-a (such as enter the office building, unlock the door, or use the elevator while carrying STA 230-a), without providing user credentials such as an access card, hardware token, key fob, etc.

Accordingly, the system 200 may provide multi-modal user identification and classification techniques which may improve user identification. For example, the system 200 may provide a platform that may interject into the flow of traffic from STAs connected to the platform (such as the STAs 230-a through 230-f) and provide unique services that considerably enhance security and user experience.

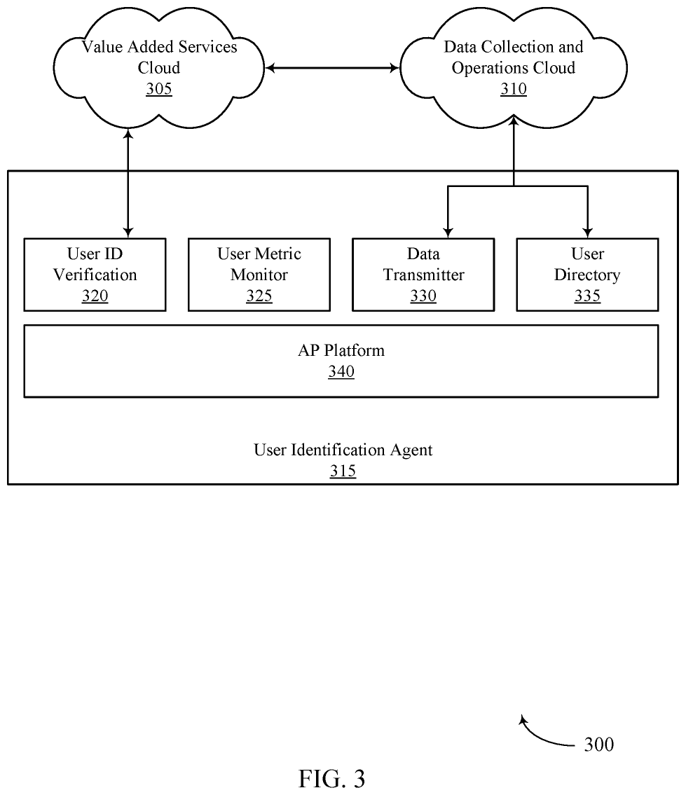

FIG. 3 illustrates shows a block diagram of an example AP 300 that supports user identification in radio frequency environments. The AP may include a user identification agent 315 in communication with a value-added services cloud 305 and a data collection and operations cloud 310. In some examples, the AP 300 may implement aspects of systems 100 and 200. For example, the value-added services cloud 305 and the data collection and operations cloud 310 may be one or more corresponding devices as described in FIG. 1, such as the cloud platform 145 in FIG. 1. In some examples, the value-added services cloud 305 may be an example of aspects of the value-added services cloud 205, and the data collection and operations cloud 310 may be an example of aspects of the data collection and operations cloud 210 as described in FIG. 2.

The user identification agent 315 may be an example of aspects of a user identification agent associated with APs 110 or a user identification agent associated with APs 225. In the example of FIG. 3, the user identification agent 315 may include a user ID verification component 320, a user metric monitor 325, a data transmitter 330, a user directory 335, and an AP platform 340. The user ID verification component 320 may verify fingerprints received or collected by the user metric monitor 325 and accordingly inject a corresponding user token (such as an attested user token) for identifying a user into the traffic stream. In some examples, the user token may include a user ID and an identification criteria associated with the user. In some examples, the user ID verification component 320 may include the token in a header of a packet associated with wireless traffic related to a value-added service (such as include the token as a header into Hypertext Transfer Protocol Secure (HTTPS) traffic). The value-added services cloud 305 may extract and send the header to the data collection and operations cloud 310 for validation and extraction of the user ID.

The user metric monitor 325 may continuously monitor for the presence of individual users or user STAs. The data transmitter 330 may provide an attestation of the AP (such as the AP associated with the user identification agent 315), for example, based on a hardware root of trust, to the cloud (such as the data collection and operations cloud 310). For example, the data transmitter 330 may provide an attestation of the AP associated with user identification agent 315 to the data collection and operations cloud 310. In some examples, based on the attestation of the AP, the data collection and operations cloud 310 may securely verify the identity and security state of the AP. In some examples, the data transmitter 330 may transmit any data applicable to fingerprinting a user such as voice data, CSI data, peripheral devices (such as wearables such as earbuds, fitness bands, etc.) associated with the user, etc.

The user directory 335 may maintain a list of users, corresponding fingerprints (such as voice, CSI, wearables, etc.), and corresponding application policies (such as rules, criteria) for user identification. The user directory 335 may be stored at the AP (such as the AP associated with the user identification agent 315). In some examples, an application policy or policy setting may specify that a fingerprint associated with a STA (such as STA 115 based on channel information) or a fingerprint of a user associated with the STA is sufficient for user identification, while another application policy or policy setting may specify that one or both of the fingerprints and one or more pieces of additional identification information (such as biometrics data, voice data, presence of a STA (for example, a peripheral device or wearable device such as a watch, earbuds, fitness bands, etc.) associated with the user profile and the device) are necessary for user identification. The application policies may be defined, for example, by the value-added services cloud 305.

The AP platform 340 may provide the user identification agent 315 with full access for the monitoring of radio frequency traffic and connected STAs by AP s included in the mesh network 220. In an example, the AP platform 340 may provide an AP associated with the user identification agent 315 (such as AP s 225-a through 225-g) with full access for the monitoring of radio frequency traffic and connected STAs (such as STAs 230-a through 230-f) in the mesh network 220. For example, the AP platform 340 may provide user identification agent 315 (such as AP s 225-a through 225-g) with permissions for monitoring activity by STAs (such as STAs 230-a through 230-f) in the mesh network 220, as well as routing and timing information associated with the mesh network 220.

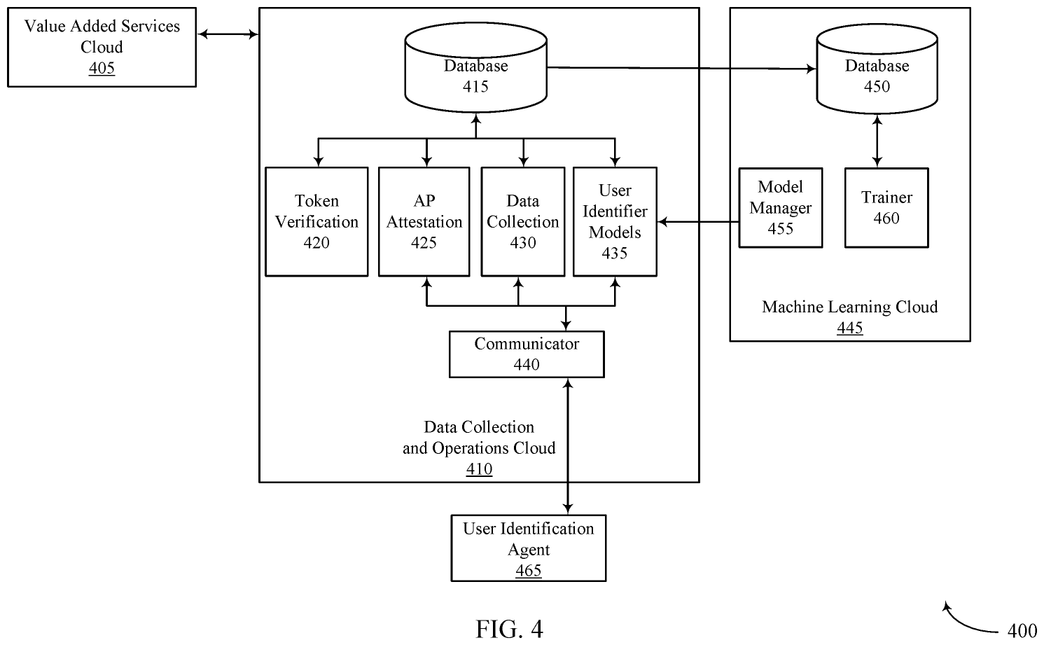

FIG. 4 shows a block diagram of an example cloud system 400 that supports user identification in radio frequency environments. In some examples, the cloud system 400 may implement aspects of systems 100 and 200. For example, the cloud system 400 may be an example of aspects of the cloud platform 145 as described herein in FIG. 1. The cloud system 400 may include a value-added services cloud 405, a data collection and operations cloud 410, and a machine learning cloud 445.

The value-added services cloud 405 may include application services that may benefit from transparent and pervasive user identification at the network edge (such as at the edge of a cellular network). The value-added services cloud 405 may be an example of aspects of the value-added services cloud 205 and the value-added services cloud 305 as described herein.

The data collection and operations cloud 410 may aggregate data from the network (such as network 120 of FIG. 1, mesh network 220 of FIG. 2). The data collection and operations cloud 410 may be an example of aspects of the data collection and operations cloud 210 and the data collection and operations cloud 310. The data collection and operations cloud 410 may include, for example, a database 415, a token verification component 420, an AP attestation component 425, a data collection component 430, and user identifier models 435, a communicator 440. The machine learning cloud 445 may include capabilities for learning user fingerprints (such as voice data, channel information data, wearables associated with the user, etc.) for identifying a user. The machine learning cloud 445 may include, for example, a neural network. The machine learning cloud 445 may be an example of aspects of machine learning training and analytics cloud 215.

The value-added services cloud 405 may interface with the data collection and operations cloud 410 to register user IDs that need to be authenticated at the network (such as at the network 120 of FIG. 1, or at the mesh network 220 of FIG. 2). Additionally, or alternatively, the value-added services cloud 405 may interface with the data collection and operations cloud 410 (such as token verification component 420) to verify user ID tokens received by the value-added services cloud 405 from the network. Additionally, or alternatively, the value-added services cloud 405 may interface with the data collection and operations cloud 410 (such as user identifier models 435) to specify application policies or policy settings (such as rules, criteria) for user identification.

The AP attestation component 425 may attest APs (such as APs 225-a through 225-g, an AP associated with user identification agent 465), for example, using hardware root of trust, before the data collection and operations cloud 410 collects data from the APs. The data collection and operations cloud 410 may transmit the aggregated data to the machine learning cloud 445 for training fingerprint models (such as at trainer 460) for identifying individual users (such as users 235-a and 235-b) or user devices (such as STAs 230-a through 230-f) at the network edge. Model manager 455 may store or manage the trained fingerprint models. The machine learning cloud 445 may transmit the trained fingerprint models to the data collection and operations cloud 410, which may transmit or push the trained fingerprint models to the user identification agent 465 via the communicator 440. The user identification agent 465 may be an example of aspects of user identification agents associated with the APs 225-a through 225-g or user identification agent 315. The user identification agent 465 may monitor data traffic (such as Wi-Fi data traffic) based on the trained fingerprint models.

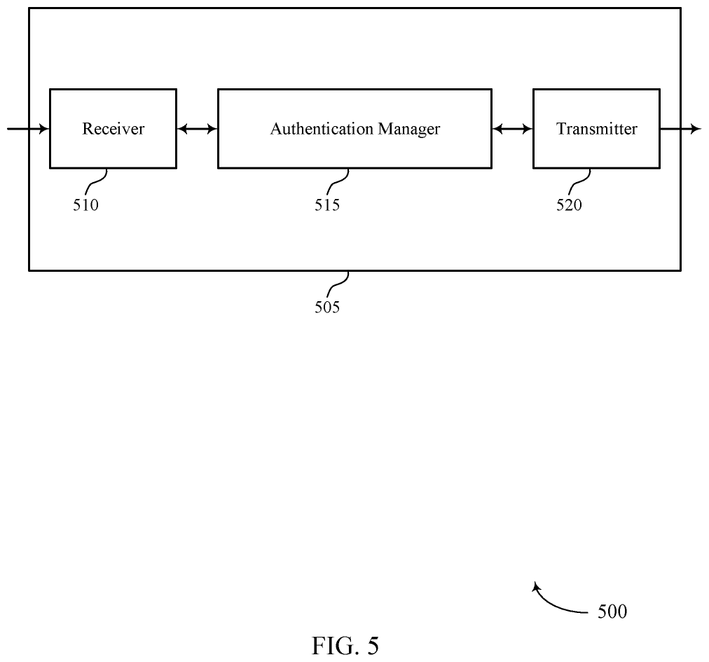

FIG. 5 shows a block diagram 500 of an example device 505 that supports user identification in radio frequency environments. The device 505 may be an example of aspects of an AP as described herein. The device 505 may include a receiver 510, an authentication manager 515, and a transmitter 520. The device 505 also may include a processor. Each of these components may be in communication with one another (such as via one or more buses).

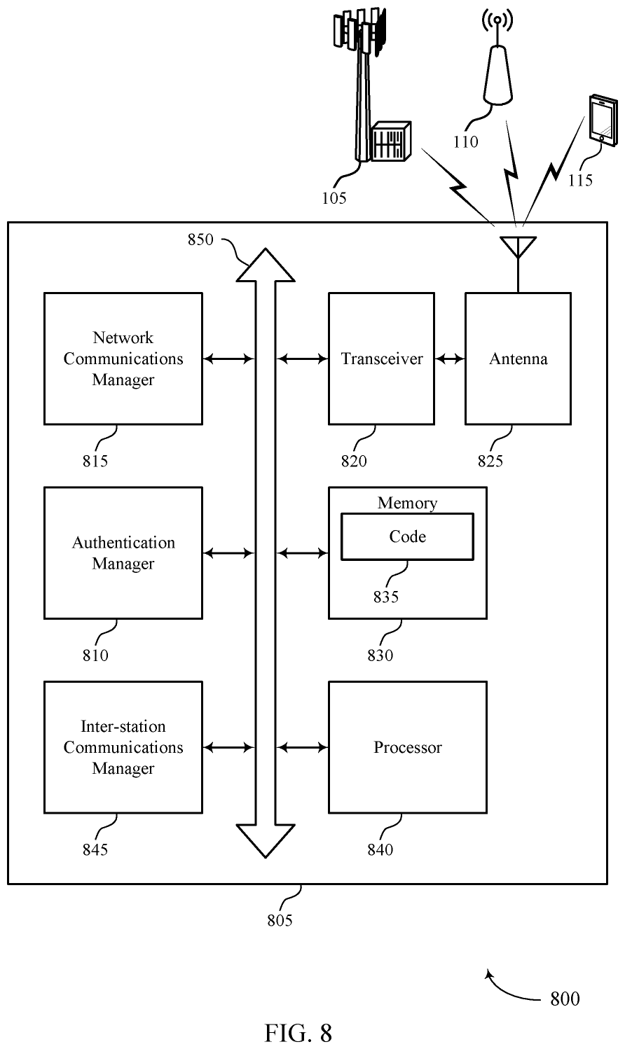

The receiver 510 may receive information such as packets, user data, or control information associated with various information channels (such as control channels, data channels, and information related to user identification in radio frequency environments, etc.). Information may be passed on to other components of the device. The receiver 510 may be an example of aspects of the transceiver 820 described with reference to FIG. 8. The receiver 510 may utilize a single antenna or a set of antennas.

The authentication manager 515 may collect channel information from a STA in a mesh network, receive, from a cloud platform, a user profile including one or more of a fingerprint of the STA and a fingerprint of a user associated with the STA based on the channel information, determine a profile of wireless traffic from the STA in the mesh network, identify one or more of the STA and the user associated with the STA based on comparing the user profile to the profile of the wireless traffic, and authenticate one or more of the STA and the user associated with the STA based on the identifying.

The authentication manager 515 as described herein may be implemented to realize one or more potential advantages. One implementation may allow the device 505 to provide multi-modal user identification and classification techniques which may support improved user identification, among other advantages. For example, the device 505 may include features for enhancing security and user experience, as the device 505 may be able to compare an existing user profile to the profile of the wireless traffic, and accordingly, authenticate one or more of the STA and the user associated with the STA. Additionally, or alternatively, the device 505 may include features for promoting improved multi-modal user identification and classification techniques that may reduce or eliminate dependencies on user interaction for user identification procedures, as the device 505 may be able to authenticate one or more of the STA and the user associated with the STA without requiring the user to take a specific action (such as provide a user input). Additionally, or alternatively, the device 505 may include features for multi-modal user identification and classification based on one or both of the fingerprints and one or more pieces of additional identification information (such as biometrics data, voice data, presence of a STA (for example, a peripheral device or wearable device such as a watch, earbuds, fitness bands, etc.) associated with the user profile and the device 505), which may add additional advantages for increased security. The authentication manager 515 may be an example of aspects of the authentication manager 810 described herein.

The authentication manager 515, or its sub-components, may be implemented in hardware, code (such as software or firmware) executed by a processor, or any combination thereof. If implemented in code executed by a processor, the functions of the authentication manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The authentication manager 515, or its sub-components, may be physically located at various positions, including being distributed such that portions of functions are implemented at different physical locations by one or more physical components. In some examples, the authentication manager 515, or its sub-components, may be a separate and distinct component. In some examples, the authentication manager 515, or its sub-components, may be combined with one or more other hardware components, including but not limited to an input/output (I/O) component, a transceiver, a network server, another computing device, one or more other components described in the present disclosure, or a combination thereof.

The transmitter 520 may transmit signals generated by other components of the device. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

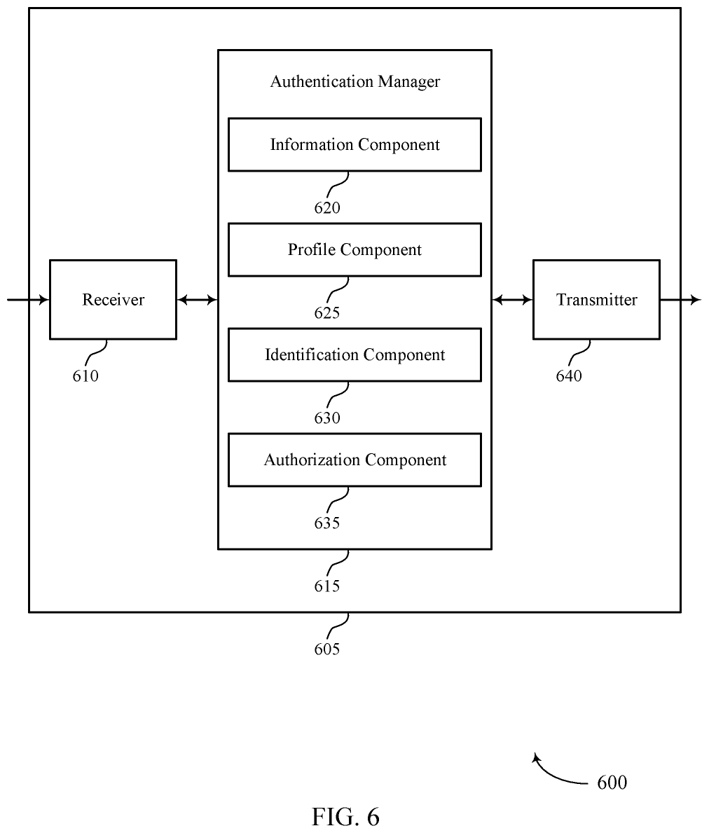

FIG. 6 shows a block diagram 600 of an example device 605 that supports user identification in radio frequency environments. The device 605 may be an example of aspects of a device 505 or an AP 110 as described herein. The device 605 may include a receiver 610, an authentication manager 615, and a transmitter 640. The device 605 also may include a processor. Each of these components may be in communication with one another (such as via one or more buses).

The receiver 610 may receive information such as packets, user data, or control information associated with various information channels (such as control channels, data channels, and information related to user identification in radio frequency environments, etc.). Information may be passed on to other components of the device. The receiver 610 may be an example of aspects of the transceiver 820 described with reference to FIG. 8. The receiver 610 may utilize a single antenna or a set of antennas.

The authentication manager 615 may be an example of aspects of the authentication manager 515 as described herein. The authentication manager 615 may include an information component 620, a profile component 625, an identification component 630, and an authorization component 635. The authentication manager 615 may be an example of aspects of the authentication manager 810 described herein.

The information component 620 may collect channel information from a STA in a mesh network. The profile component 625 may receive, from a cloud platform, a user profile including one or more of a fingerprint of the STA and a fingerprint of a user associated with the STA based on the channel information and determine a profile of wireless traffic from the STA in the mesh network. The identification component 630 may identify one or more of the STA and the user associated with the STA based on comparing the user profile to the profile of the wireless traffic. The authorization component 635 may authenticate one or more of the STA and the user associated with the STA based on the identifying. Accordingly, the described user identification and classification techniques may promote improved user identification, classification, and authentication for enhancing security and user experience, among other advantages.

The transmitter 640 may transmit signals generated by other components of the device. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

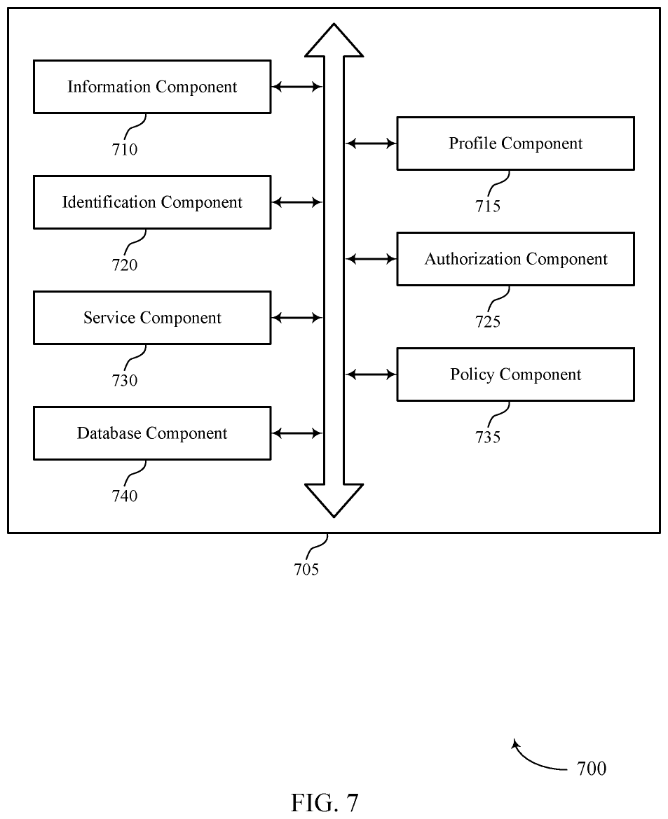

FIG. 7 shows a block diagram 700 of an example authentication manager 705 that supports user identification in radio frequency environments. The authentication manager 705 may be an example of aspects of a authentication manager 515, a authentication manager 615, or a authentication manager 810 described herein. The authentication manager 705 may include an information component 710, a profile component 715, an identification component 720, an authorization component 725, a service component 730, a policy component 735, and a database component 740. Each of these modules may communicate, directly or indirectly, with one another (such as via one or more buses).

The information component 710 may collect channel information from a STA in a mesh network. In some examples, the information component 710 may receive CSI from the STA. The CSI may include a measurement of one or more OFDM carriers associated with the STA. In some examples, information component 710 may monitor round trip information between the STA and an AP in the mesh network. The round trip information may include one or more of a round trip time, a round trip phase offset, and an angle of arrival. In some examples, the information component 710 may monitor one or more of a signal strength, a signal power, and a signal quality of the STA in the mesh network. In some examples, the information component 710 may obtain biometric information from the user associated with the STA. The biometric information may include one or more of voice recognition information, facial recognition information, or physiological recognition information. In some examples, the information component 710 may transmit the channel information to a cloud platform.

The profile component 715 may receive, from the cloud platform, a user profile including one or more of a fingerprint of the STA and a fingerprint of a user associated with the STA based on the channel information. In some examples, the profile component 715 may determine a profile of wireless traffic from the STA in the mesh network. The profile component 715 may determine a difference between the user profile and the profile of the wireless traffic based on the comparing the user profile and the profile of the wireless traffic. For example, the profile component 715 may compare one or more of the fingerprint of the STA and the fingerprint of the user associated with the STA to a fingerprint of the wireless traffic. The profile component 715 may determine that an other user is operating the STA based on the difference between the user profile and the profile of the wireless traffic. In some examples, the profile component 715 may identify an additional user profile of the user associated with an additional STA in the mesh network. In some examples, the profile component 715 may receive, from the cloud platform, the user profile based on transmitting the channel information to the cloud platform. In some examples, the user profile may be determined based on a machine learning scheme.

The identification component 720 may identify one or more of the STA and the user associated with the STA based on comparing the user profile to the profile of the wireless traffic. In some examples, the identification component 720 may identify the one or more of the STA and the user associated with the STA based on comparing the additional user profile to the profile of the wireless traffic. The authorization component 725 may authenticate one or more of the STA and the user associated with the STA based on the identifying. In some examples, the authorization component 725 may authenticate one or more of the STA and the user associated with the STA to a value-added service based on comparing the user profile to the profile of the wireless traffic relating to the value-added service. In some examples, the authorization component 725 may transmit authentication credentials to the value-added service based on the authentication. In some examples, the authorization component 725 may include a token in a header of a packet associated with the wireless traffic relating to the value-added service, the token including the authentication credentials.

In some examples, the authorization component 725 may perform an action according to a setting of the STA based on the other user operating the STA. For example, the authorization component 725 may prevent access to one or more features of the STA. In some examples, the authorization component 725 may perform an authentication and verification of the AP to the cloud platform, the authentication and verification including one or more of a STA identifier and a security mode of the AP. In some examples, the authorization component 725 may transmit the channel information to the cloud platform based on the authentication and verification.

The service component 730 may determine that the wireless traffic is associated with the value-added service. The policy component 735 may identify a policy setting associated with the value-added service, where authenticating the one or more of the STA and the user associated with the STA to the value-added service may be based on the policy setting. In some examples, the policy component 735 may determine additional information of the user associated with the STA based on the policy setting, the additional information including biometric information, temporal information, location information of an additional STA associated with the user, or usage information of the additional STA associated with the user. In some examples, the policy component 735 may identify the one or more of the STA and the user associated with the STA based on the additional information. The database component 740 may generate a local database including a set of users associated with the STA, a set of user profiles including a set of fingerprints, each fingerprint of the set corresponding to different users of the set of users, and a set of policies corresponding to the set of users, where comparing the user profile to the profile of the wireless traffic is further based on the local database.

FIG. 8 shows a diagram of an example system 800 including a device 805 that supports user identification in radio frequency environments. The device 805 may be an example of or include the components of device 505, device 605, or a AP as described herein. The device 805 may include components for bi-directional voice and data communications including components for transmitting and receiving communications, including an authentication manager 810, a network communications manager 815, a transceiver 820, an antenna 825, memory 830, a processor 840, and an inter-station communications manager 845. These components may be in electronic communication via one or more buses (such as bus 850).

The authentication manager 810 may collect channel information from a STA in a mesh network, receive, from a cloud platform, a user profile including one or more of a fingerprint of the STA and a fingerprint of a user associated with the STA based on the channel information, determine a profile of wireless traffic from the STA in the mesh network, identify one or more of the STA and the user associated with the STA based on comparing the user profile to the profile of the wireless traffic, and authenticate one or more of the STA and the user associated with the STA based on the identifying.

The network communications manager 815 may manage communications with the core network (such as via one or more wired backhaul links). For example, the network communications manager 815 may manage the transfer of data communications for client devices, such as one or more STAs 115.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 also may include a modem to modulate the packets and provide the modulated packets to the antennas for transmission, and to demodulate packets received from the antennas. In some cases, the device 805 may include a single antenna 825. However, in some cases the device 805 may have more than one antenna 825, which may be capable of concurrently transmitting or receiving multiple wireless transmissions.

The memory 830 may include random access memory (RAM) and read only memory (ROM). The memory 830 may store computer-readable, computer-executable code 8 35 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into processor 840. The processor 840 may be configured to execute computer-readable instructions stored in a memory to perform various functions (such as functions or tasks supporting user identification in radio frequency environments).

The inter-station communications manager 845 may manage communications with base station 105, or APs 110, and may include a controller or scheduler for controlling communications with STAs 115 in cooperation with base stations 105 or other APs 110.

As detailed above, the authentication manager 810 and/or one or more components of the authentication manager 810 may perform and/or be a means for performing, either alone or in combination with other elements, one or more operations for user identification in radio frequency environments.

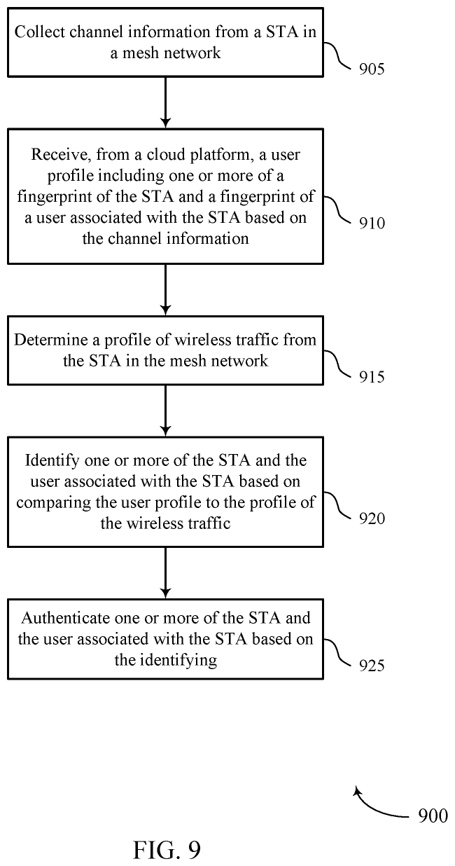

FIG. 9 shows a flowchart illustrating a method 900 that supports user identification in radio frequency environments. The operations of method 900 may be implemented by an AP or its components as described herein. For example, the operations of method 900 may be performed by an authentication manager as described with reference to FIGS. 5-8. In some examples, an AP may execute a set of instructions to control the functional elements of the AP to perform the functions described below. Additionally, or alternatively, an AP may perform aspects of the functions described below using special-purpose hardware.

At 905, the AP may collect channel information from a STA in a mesh network. The operations of 905 may be performed according to the methods described herein. In some examples, aspects of the operations of 905 may be performed by an information component as described with reference to FIGS. 5-8.

At 910, the AP may receive, from a cloud platform, a user profile including one or more of a fingerprint of the STA and a fingerprint of a user associated with the STA based on the channel information. The operations of 910 may be performed according to the methods described herein. In some examples, aspects of the operations of 910 may be performed by a profile component as described with reference to FIGS. 5-8.

At 915, the AP may determine a profile of wireless traffic from the STA in the mesh network. The operations of 915 may be performed according to the methods described herein. In some examples, aspects of the operations of 915 may be performed by a profile component as described with reference to FIGS. 5-8.

At 920, the AP may identify one or more of the STA and the user associated with the STA based on comparing the user profile to the profile of the wireless traffic. The operations of 920 may be performed according to the methods described herein. In some examples, aspects of the operations of 920 may be performed by an identification component as described with reference to FIGS. 5-8.

At 925, the AP may authenticate one or more of the STA and the user associated with the STA based on the identifying. The operations of 925 may be performed according to the methods described herein. In some examples, aspects of the operations of 925 may be performed by an authorization component as described with reference to FIGS. 5-8. Accordingly, the described operations of method 900 as implemented by the AP or its components may promote improved user identification, classification, and authentication techniques for enhancing security and user experience, among other advantages.

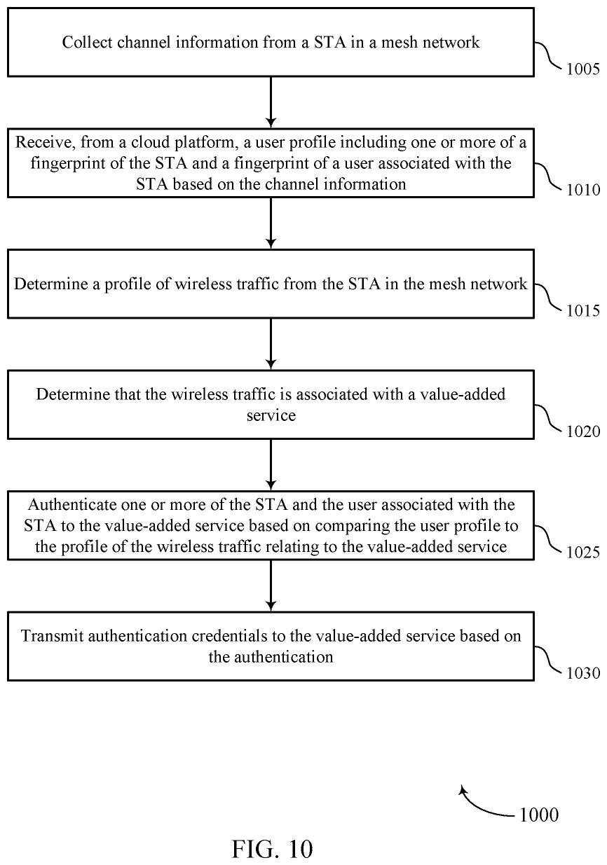

FIG. 10 shows a flowchart illustrating a method 1000 that supports user identification in radio frequency environments. The operations of method 1000 may be implemented by an AP or its components as described herein. For example, the operations of method 1000 may be performed by an authentication manager as described with reference to FIGS. 5-8. In some examples, an AP may execute a set of instructions to control the functional elements of the AP to perform the functions described below. Additionally, or alternatively, an AP may perform aspects of the functions described below using special-purpose hardware.

At 1005, the AP may collect channel information from a STA in a mesh network. The operations of 1005 may be performed according to the methods described herein. In some examples, aspects of the operations of 1005 may be performed by an information component as described with reference to FIGS. 5-8.

At 1010, the AP may receive, from a cloud platform, a user profile including one or more of a fingerprint of the STA and a fingerprint of a user associated with the STA based on the channel information. The operations of 1010 may be performed according to the methods described herein. In some examples, aspects of the operations of 1010 may be performed by a profile component as described with reference to FIGS. 5-8.

At 1015, the AP may determine a profile of wireless traffic from the STA in the mesh network. The operations of 1015 may be performed according to the methods described herein. In some examples, aspects of the operations of 1015 may be performed by a profile component as described with reference to FIGS. 5-8.

At 1020, the AP may determine that the wireless traffic is associated with a value-added service. The operations of 1020 may be performed according to the methods described herein. In some examples, aspects of the operations of 1020 may be performed by a service component as described with reference to FIGS. 5-8.

At 1025, the AP may authenticate one or more of the STA and the user associated with the STA to the value-added service based on comparing the user profile to the profile of the wireless traffic relating to the value-added service. The operations of 1025 may be performed according to the methods described herein. In some examples, aspects of the operations of 1025 may be performed by an authorization component as described with reference to FIGS. 5-8.

At 1030, the AP may transmit authentication credentials to the value-added service based on the authentication. The operations of 1030 may be performed according to the methods described herein. In some examples, aspects of the operations of 1030 may be performed by an authorization component as described with reference to FIGS. 5-8. Accordingly, the described operations of method 1000 as implemented by the AP or its components may promote improved user identification, classification, and authentication techniques for enhancing security and user experience, among other advantages.

An orthogonal frequency-division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method at an access point, comprising:
collecting channel information from a station in a mesh network;
receiving, from a cloud platform, a user profile comprising one or more of a fingerprint of the station and a fingerprint of a user associated with the station based at least in part on the channel information;
determining a profile of wireless traffic from the station in the mesh network;
identifying one or more of the station and the user associated with the station based at least in part on comparing the user profile to the profile of the wireless traffic; and
authenticating one or more of the station and the user associated with the station based at least in part on the identifying.

2. The method of claim 1, wherein collecting the channel information comprises:
receiving channel state information from the station, the channel state information comprising a measurement of one or more orthogonal frequency-division multiplexing (OFDM) carriers associated with the station.

3. The method of claim 1, wherein collecting the channel information comprises:
monitoring round trip information between the station and the access point in the mesh network, wherein the round trip information comprises one or more of a round trip time, a round trip phase offset, and an angle of arrival.

4. The method of claim 1, wherein collecting the channel information comprises:
monitoring one or more of a signal strength, a signal power, and a signal quality of the station in the mesh network.

5. The method of claim 1, wherein collecting the channel information comprises:
obtaining biometric information from the user associated with the station, wherein the biometric information comprises one or more of voice recognition information, facial recognition information, or physiological recognition information.

6. The method of claim 1, wherein determining the profile of the wireless traffic from the station in the mesh network comprises:
determining that the wireless traffic is associated with a value-added service;
authenticating one or more of the station and the user associated with the station to the value-added service based at least in part on comparing the user profile to the profile of the wireless traffic relating to the value-added service; and
transmitting authentication credentials to the value-added service based at least in part on the authentication.

7. The method of claim 6, further comprising:
identifying a policy setting associated with the value-added service, wherein authenticating the one or more of the station and the user associated with the station to the value-added service is further based at least in part on the policy setting.

8. The method of claim 7, further comprising:
determining additional information of the user associated with the station based at least in part on the policy setting, the additional information comprising biometric information, temporal information, location information of an additional station associated with the user, or usage information of the additional station associated with the user,
wherein identifying the one or more of the station and the user associated with the station is further based at least in part on the additional information.

9. The method of claim 6, wherein transmitting the authentication credentials to the value-added service comprises:
including a token in a header of a packet associated with the wireless traffic relating to the value-added service, the token comprising the authentication credentials.

10. The method of claim 1, wherein determining the profile of the wireless traffic from the station in the mesh network comprises:
determining a difference between the user profile and the profile of the wireless traffic based at least in part on the comparing; and
identifying an additional user profile of the user associated with an additional station in the mesh network,
wherein identifying the one or more of the station and the user associated with the station is further based at least in part on comparing the additional user profile to the profile of the wireless traffic.

11. The method of claim 1, wherein determining the profile of the wireless traffic from the station in the mesh network comprises:
determining a difference between the user profile and the profile of the wireless traffic based at least in part on the comparing;
determining that an other user is operating the station based at least in part on the difference between the user profile and the profile of the wireless traffic; and
performing an action according to a setting of the station based at least in part on the other user operating the station.

12. The method of claim 11, wherein performing the action according to the setting of the station comprises:
preventing access to one or more features of the station.

13. The method of claim 1, further comprising:
performing an authentication and verification of the access point to the cloud platform, the authentication and verification comprising one or more of a station identifier and a security mode of the access point,
wherein transmitting the channel information to the cloud platform is further based at least in part on the authentication and verification.

14. The method of claim 1, wherein comparing the user profile to the profile of the wireless traffic comprises:
comparing one or more of the fingerprint of the station and the fingerprint of the user associated with the station to a fingerprint of the wireless traffic.

15. The method of claim 1, further comprising:
generating a local database comprising a set of users associated with the station, a set of user profiles comprising a set of fingerprints, each fingerprint of the set corresponding to different users of the set of users, and a set of policies corresponding to the set of users, wherein comparing the user profile to the profile of the wireless traffic is further based at least in part on the local database.

16. The method of claim 1, further comprising:
transmitting the channel information to the cloud platform,
wherein receiving, from the cloud platform, the user profile is based at least in part on the transmitting, and the user profile is determined based at least in part on a machine learning scheme.

17. An apparatus, comprising:
a processor,
memory coupled with the processor; and
instructions stored in the memory and executable by the processor to cause the apparatus to:
collect channel information from a station in a mesh network;
receive, from a cloud platform, a user profile comprising one or more of a fingerprint of the station and a fingerprint of a user associated with the station based at least in part on the channel information;
determine a profile of wireless traffic from the station in the mesh network;
identify one or more of the station and the user associated with the station based at least in part on comparing the user profile to the profile of the wireless traffic; and
authenticate one or more of the station and the user associated with the station based at least in part on the identifying.

18. The apparatus of claim 17, wherein the instructions to determine the profile of the wireless traffic from the station in the mesh network are executable by the processor to cause the apparatus to:
determine that the wireless traffic is associated with a value-added service;
authenticate one or more of the station and the user associated with the station to the value-added service based at least in part on comparing the user profile to the profile of the wireless traffic relating to the value-added service; and
transmit authentication credentials to the value-added service based at least in part on the authentication.

19. The apparatus of claim 18, wherein the instructions are further executable by the processor to cause the apparatus to:
identify a policy setting associated with the value-added service, wherein authenticating the one or more of the station and the user associated with the station to the value-added service is further based at least in part on the policy setting.

20. An apparatus, comprising:
means for collecting channel information from a station in a mesh network;
means for receiving, from a cloud platform, a user profile comprising one or more of a fingerprint of the station and a fingerprint of a user associated with the station based at least in part on the channel information;
means for determining a profile of wireless traffic from the station in the mesh network;
means for identifying one or more of the station and the user associated with the station based at least in part on comparing the user profile to the profile of the wireless traffic; and
means for authenticating one or more of the station and the user associated with the station based at least in part on the identifying.
